(19) United States
(12) Patent Application Publication
(10) Pub. No.: US 2009/0256763 A1
(43) Pub. Date: Oct. 15, 2009

(54) Multiband folded loop antenna

(75) Inventors: Yun-Wen Chi, Taipei County (TW); Kin-Lu Wong, Kaohsiung City (TW)

Correspondence Address: OLIFF & BERRIDGE, PLC, P.O. BOX 320850, ALEXANDRIA, VA, 22320-4850, US

(73) Assignee: ACER INCORPORATED, Taipei Hsien (TW)

(21) Appl. No.: 12/213,166

(22) Filed: Jun. 16, 2008

(30) Foreign Application Priority Data
Apr. 9, 2008 (TW) 097112916

(51) Int. Cl. H01Q 11/12

(52) U.S. Cl. 343/741

(57) ABSTRACT

The present invention relates to a multiband folded loop antenna comprising a dielectric substrate, a ground plane, a radiating portion and a matching circuit. The ground plane is located on the dielectric substrate and has a grounding point. The radiating portion comprises a supporter, a loop strip, and a tuning patch. The loop strip has a length about half wavelength of the antenna's lowest resonant frequency. The loop strip has a feeding end and a grounding end, with the grounding end electrically connected to the grounding point on the ground plane. The loop strip is folded into a three-dimensional structure and is supported by the supporter. The tuning patch is electrically connected to the loop strip. The matching circuit is located on the dielectric substrate with one terminal electrically connected to the feeding end of the loop strip and another terminal to a signal source.

### FIELD OF THE INVENTION

The present invention relates to a loop antenna, and more particularly to a multiband folded loop antenna suitable for embedding in a cellular phone.

### BACKGROUND OF THE INVENTION

With the fast development in wireless communication technologies, the antenna plays an increasingly important role in various kinds of wireless communication products. Particularly, due to the tendency of developing lightweight and compact wireless communication products, the antenna size, particularly the antenna height, would have important influence on the value of wireless communication product. However, taking the embedded cell phone antenna as an example, while the space inside the cell phone allowed for the antenna is much limited than ever before, the antenna still is required to support multiband operation in order to meet the actual demands in the wireless communication field. It has been found that the loop antenna is more suitable for the embedded cell phone antenna compared to the conventional monopole antenna or planar antenna. This is because the loop antenna may be formed by bending and winding a thin metal wire. Unlike the conventional monopole antenna or planar antenna that relies on wide metal sheet to increase the bandwidth characteristic, the bandwidth performance of the loop antenna is not significantly lowered due to use of thin metal wire with small wire thickness. Therefore, the loop antenna may have a relatively small size while achieves the same multiband operation as the conventional cell phone antenna.

However, the low frequency band of the loop antenna with a largely reduced size can cover GSM 850 or GSM 900, but has difficulty in simultaneously covering GSM 850/900 dual-band operation. Therefore, it is necessary to develop the technique for increasing the bandwidth of the loop antenna. U.S. Pat. No. 7,242,364 B2 entitled “Dual-Resonant Antenna” discloses a technique of applying a matching circuit in the embedded cell phone antenna used in the mobile communication system, so that the single-resonant mode of the antenna can have the dual-resonant characteristic to achieve the purpose of increasing the bandwidth of the antenna. However, U.S. Pat. No. 7,242,364 B2 only teaches the application of the above technique in the embedded cell phone antenna for single-band operation, but such technique could not be directly applied to a dual-band (such as 900 and 1800 MHz) cell phone antenna. Meanwhile, such technique is only applicable to cell phone antenna having a length about quarter-wavelength of resonant frequency of the antenna.

To solve the above problem, a multiband folded loop antenna is developed, in which a metal strip is bent into a loop and then folded into a three-dimensional structure occupying a small volume. With respect to the operating technique of the folded loop antenna, the 0.5-wavelength resonant mode of the loop strip is used for the low frequency band of the antenna, and the higher-order resonant modes of the loop strip are synthesized into a wideband operation for the high frequency band. Besides, a matching circuit is further used in such antenna for the low frequency band to have dual-resonant characteristic and increased bandwidth. Besides, at least one tuning patch is further used in such antenna to improve the match at the high frequency band. With the above arrangements, the antenna is able to provide five-band operation covering GSM 850/900/1800/1900/UMTS bands and meet the requirement of being applied to cell phone systems.

### SUMMARY OF THE INVENTION

One of objectives of the present invention is to provide a novel antenna for cell phone, such antenna not only provides band operation covering GSM 850 (824˜894 MHz), 900 (890˜960 MHz), 1800 (1710˜1880 MHz), 1900 (1850˜1990 MHz), and UMTS (1920˜2170 MHz) bands, but also has a size smaller than that of conventional cell phone antennas covering the same band operation.

Besides, another objective of the present invention is to provide a novel antenna for cell phone, such antenna has advantage of having simplified structure and definite operating mechanism, easily manufacturing, and saving space in a cell phone.

To achieve the above and other objects, the antenna in accordance with the present invention comprises a dielectric substrate, a ground plane, a radiating portion, and a matching circuit. The ground plane has a grounding point and is located on the dielectric substance. The radiating portion comprises a supporter, a loop strip, and a tuning patch. The loop strip of the radiating portion has a length about half wavelength of the antenna's lowest resonant frequency, and has a feeding end and a ground end, with the grounding end electrically connected to the grounding point of the ground plane. The loop strip is folded into a three-dimensional structure and supported by the supporter. The tuning patch of the radiating portion is electrically connected to the loop strip. The matching circuit is located on the dielectric substrate, and has one terminal electrically connected to the feeding end of the loop strip and another terminal connected to a signal source.

Preferably, the dielectric substrate can be a system circuit board of the mobile communication apparatus.

Preferably, the ground plane can be a system ground plane of a mobile communication apparatus.

Preferably, the ground plane is formed on the dielectric substrate by printing or etching.

Preferably, the material of the supporter can be air, a fiberglass substrate, a plastic material, or a ceramic material.

Preferably, the matching circuit further comprises at least one capacitance element and at least one inductance element.

In the present invention, the 0.5-wavelength resonant mode of the loop strip is used for the low frequency band of the antenna, and the loop strip higher-order resonant mode is used for the high frequency band of the antenna. Further, the matching circuit is used for the low frequency band to have the dual-resonant characteristic and increased bandwidth, and at least one tuning patch is used to improve the match at the high frequency band. The low frequency band of antenna is provided with a bandwidth of about 200 MHz from 810 to 1010 MHz to cover GSM 850/900 band operation (from 824 to 960 MHz). Moreover, the return loss of the antenna of the present invention at the low frequency band is always higher than 6 dB. Meanwhile, the high frequency band of antenna is provided with a bandwidth of about 615 MHz from 1635 to 2250 MHz to cover GSM 1800/1900/UMTS band operation (from 1710 to 2170 MHz), and the return loss of the antenna of the present invention at the high frequency band is also always higher than 6 dB to meet the application requirement. Meanwhile, the antenna of the present invention has simplified structure, definite operating mechanism, and an antenna size smaller than that of other cell phone antennas covering the same band operation. That is, the antenna of the present invention may save the space for mounting the antenna in the cell phone while maintains the multiband antenna characteristic. Therefore, the antenna of the present invention is highly valuable in terms of its wide industrial applications.

### BRIEF DESCRIPTION OF THE DRAWINGS

The structure and the technical means adopted by the present invention to achieve the above and other objects can be best understood by referring to the following detailed description of the embodiments and the accompanying drawings, wherein

FIG. 1 illustrates the structure of a multiband folded loop antenna according to a first embodiment of the present invention, wherein FIG. 1(a) illustrates the antenna structure, and FIG. 1(b) illustrates a circuit diagram of a matching circuit connected to the antenna;

FIG. 2 illustrates the structure of a multiband folded loop antenna according to a second embodiment of the present invention;

FIG. 3 is a graph illustrating the measured return loss of the antenna according to the first embodiment of the present invention;

FIG. 4 illustrates the radiation field patterns of the antenna according to the first embodiment of the present invention when providing operation covering GSM 850/900 bands; wherein FIG. 4(a) illustrates the radiation field patterns at a frequency of 859 MHz and FIG. 4(b) illustrates the radiation field patterns at a frequency of 925 MHz;

FIG. 5 illustrates the radiation field patterns of the antenna according to the first embodiment of the present invention when providing operation covering GSM 1800/1900/UMTS bands; wherein FIG. 5(a) illustrates the radiation field patterns at a frequency of 1795 MHz, FIG. 5(b) illustrates the radiation field patterns at a frequency of 1920 MHz, and FIG. 5(c) illustrates the radiation field patterns at a frequency of 2045 MHz;

FIG. 6 illustrates the antenna gain graphs of the antenna according to the first embodiment of the present invention in different band operations; wherein FIG. 6(a) illustrates the antenna gain graph when providing operation covering GSM 850/900 bands, and FIG. 6(b) illustrates the antenna gain graph when providing operation covering GSM 1800/1900/UMTS bands; and

FIGS. 7 to 10 respectively illustrate a first, a second, a third, and a fourth derived embodiment of the multiband folded loop antenna according to the present invention.

### DETAILED DESCRIPTION OF THE EMBODIMENTS

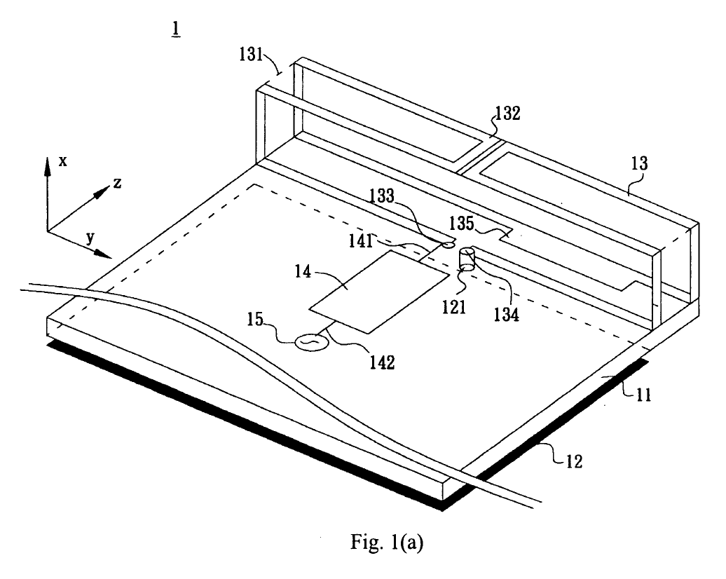

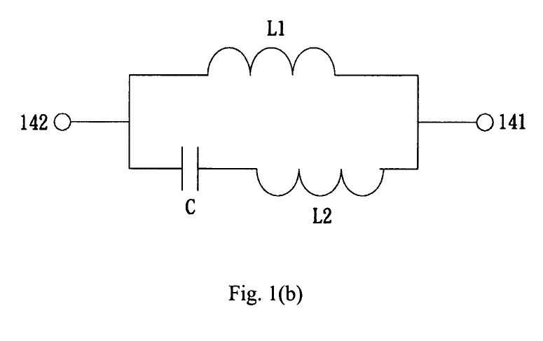

FIG. 1 illustrates the structure of a multiband folded loop antenna according to a first embodiment of the present invention, wherein FIG. 1(a) illustrates the antenna structure, and FIG. 1(b) illustrates a circuit diagram of a matching circuit connected to the antenna. The antenna 1 according to the first embodiment of the present invention comprises a dielectric substrate 11, a ground plane 12, a radiating portion 13, and a matching circuit 14. The ground plane 12 has a grounding point 121, and is located on the dielectric substrate 11. The radiating portion 13 comprises a supporter 131, a loop strip 132, and a tuning patch 135. The loop strip 132 of the radiating portion 13 has a length about half wavelength of the lowest resonant frequency of the antenna, and has a feeding end 133 and a grounding end 134 which is electrically connected to the grounding point 121 of the ground plane 12. The loop strip 132 is folded into a three-dimensional structure and is supported by the supporter 131. The tuning patch 135 of the radiating portion 13 is electrically connected to the loop strip 132. The matching circuit 14 is located on the dielectric substrate 11 with one terminal 141 electrically connected to the feeding end 133 of the loop strip 132 and another terminal 142 connected to a signal source 15.

Preferably, the dielectric substrate 11 can be a system circuit board of a mobile communication apparatus, and the ground plane 12 can be a system ground plane of a mobile communication apparatus. Preferably, the ground plane 12 can be formed on the dielectric substrate 11 by printing or etching. The matching circuit 14 further comprises at least one capacitance element and at least one inductance element.

For example, as shown in FIG. 1(b), the embodiment of matching circuit 14 comprises one capacitance element and two inductance elements. The capacitance element C and inductance element L2 are connected in series and then further connected to the inductance element L1 in parallel. Preferably, the capacitance element C may further comprise two serially connected capacitance elements.

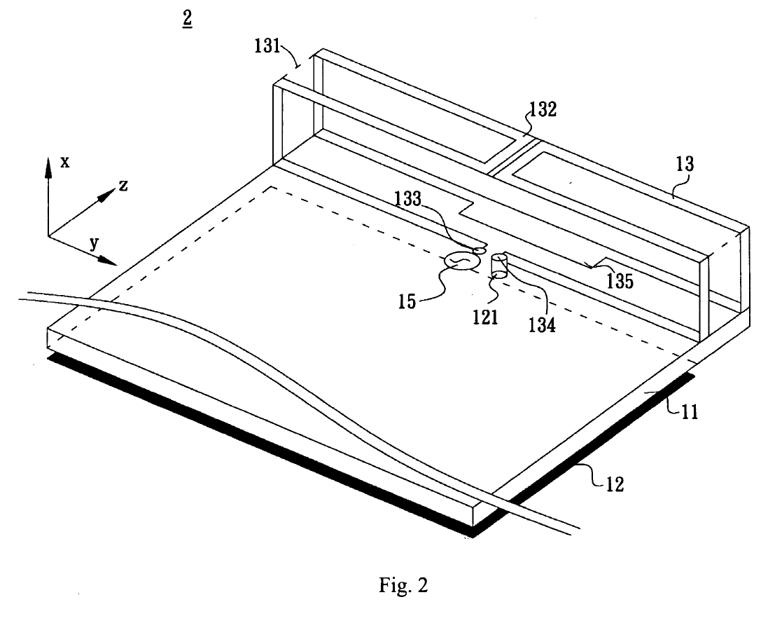

FIG. 2 illustrates a multiband folded loop antenna 2 according to a second embodiment of the present invention. The antenna 2 comprises a dielectric substrate 11, a ground plane 12, and a radiating portion 13. The ground plane 12 has a grounding point 121, and is located on the dielectric substrate 11. The radiating portion 13 comprises a supporter 131, a loop strip 132, and a tuning patch 135. The loop strip 132 of the radiating portion 13 has a length about half wavelength of the lowest resonant frequency of the antenna, and has a feeding end 133 and a grounding end 134. The feeding end 133 is electrically connected to a signal source 15, and the grounding end 134 is electrically connected to the grounding point 121 of the ground plane 12. The loop strip 132 is folded into a three-dimensional structure and supported by the supporter 131. The tuning patch 135 of the radiating portion 13 is electrically connected to the loop strip 132.

Preferably, the dielectric substrate 11 can be a system circuit board of a mobile communication apparatus, and the ground plane 12 can be a system ground plane of a mobile communication apparatus. Preferably, the ground plane 12 can be formed on the dielectric substrate 11 by printing or etching.

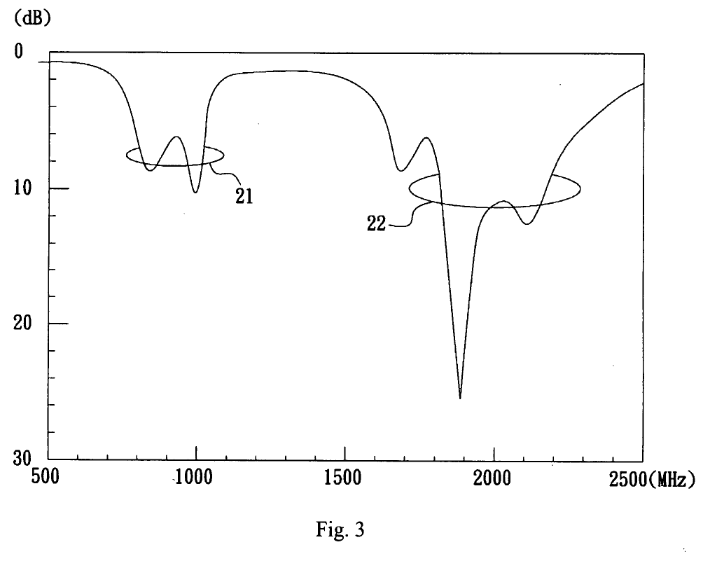

FIG. 3 illustrates the measured result of return loss of the antenna according to the first embodiment of the present invention. The antenna used in the experiment has the following sizes and element values: the dielectric substrate 11 is an FR4 (fire retardant 4) fiberglass substrate having a thickness of 0.8 mm; the ground plane 12 is 40×100 mm² in size and is formed on the surface of the dielectric substrate 11 by etching. The supporter 131 for the radiating portion 13 is air, that is, the radiating portion 13 in the first embodiment 1 is a hollow structure having a volume as small as 40×3×5 mm³ or 0.6 m³, and the loop strip 132 surrounds around an outer surface of the supporter 131. The total length of the loop strip 132 is about 180 mm, which is about half wavelength of the lowest resonant frequency of the antenna. The loop strip 132 has a feeding end 133 and a grounding end 134 which is electrically connected to the grounding point 121 of the ground plane 12. As having been mentioned above, the loop strip 132 is folded into a three-dimensional structure to enclose the supporter 131 therein. The tuning patch 135 of the radiating portion 13 has a size of 16×1.3 mm², and is electrically connected to the loop strip 132. The matching circuit 14 is located on the dielectric substrate 11 with one terminal 141 electrically connected to the feeding end 133 of the loop strip 132 of the radiating portion 13, and another terminal 142 connected to a signal source 15. The value chosen for the capacitance element C of the matching circuit 14 is 1 pF, and the value chosen for the inductance element L2 is 9.1 nH, and the value chosen for the inductance element L1 is 4.3 nH. As mentioned above, the loop strip 132 used in the experiment is 180 mm in length, which is about half wavelength of the 900 MHz. Therefore, as illustrated in FIG. 3, the half-wavelength resonant mode of the antenna 1 is used for the low frequency band 21, and the higher-order resonant mode of the antenna 1 is synthesized for the high frequency band 22, wherein the synthesized mode for the high frequency band 22 is mainly synthesized from the full-wavelength resonant mode and the 1.5-wavelength resonant mode of the loop strip 132. The technique adopted by the present invention has two characteristics: the use of the matching circuit 14 to increase an imaginary part impedance zero to the low frequency band 21, so that the resonant mode of the low frequency band 21 has dual-resonant characteristic and accordingly increased bandwidth; and the use of the tuning patch 135 to improve the impedance match at the high frequency band 22. In a situation in which the matching circuit 14 is not used, the band width of the 0.5-wavelength resonant mode of the loop strip 132 can not cover both GSM 850/900 operation bandwidths. The tuning patch 135 is used to tune the impedance match of high frequency band, so that high frequency band can cover all GSM 1800/1900/UMTS operation bands. Meanwhile, the matching circuit 14 is able to increase the bandwidth of the low frequency band without affecting the high frequency band 22. In the experiment conducted on the antenna according to the first embodiment of the present invention, the matching circuit 14 is a band-reject circuit with a 3-dB bandwidth of 170 MHz only, and a resonant center frequency of about 1100 MHz. The matching circuit 14 has dramatically varied real part impedance and imaginary part impedance at its resonant center frequency. The variation in the imaginary part impedance is helpful in increasing an imaginary part resonant zero to the 0.5-wavelength resonant mode of the loop strip 132, so that the low frequency band 21 may have the dual-resonant to achieve the wideband operation covering GSM 850/900 operation bandwidths. Meanwhile, since the matching circuit 14 has been designed to have a band-rejection center frequency of about 1100 MHz, it has little influence on the high frequency band 22. As observed from the measured result of return loss, the low frequency band 21 of the antenna of the present invention is of a 0.5-wavelength resonant mode with dual-resonant characteristic, and provides an operation bandwidth of about 200 MHz (from 810 to 1010 MHz) for covering both GSM 850/900 operating bands, and the return loss of the antenna 1 within this low frequency band is always higher than 6 dB. On the other hand, the high frequency band 22 of the antenna of the present invention provides an operating bandwidth of about 615 MHz (from 1635 to 2250 MHz) for covering GSM 1800/1900/UMTS operation bands, and the return loss within this high frequency band is also higher than 6 dB to satisfy the application requirements.

The antenna 2 according to the second embodiment of the present invention as shown in FIG. 2 is different from the antenna 1 shown in FIG. 1 in that the radiating portion 13 of the antenna 2 has a size of 40×5×6 mm³ or 1.2 cm³, which is larger than the radiating portion 13 in the antenna 1. To produce this larger antenna 2, a manufacturer needs only to change the position at where the tuning patch 135 is electrically connected to the loop strip 132 to achieve the operation covering all GSM 850/900/1800/1900/UMTS bands. This means whether to use the matching circuit 14 depends on the size and space occupied by the antenna. When the antenna has a volume so reduced that the low frequency band of the antenna fails to cover both GSM 850/900 bands, the use of the matching circuit 14 as in the antenna 1 of the present invention would enable the low frequency band to have the dual-resonant phenomenon and accordingly, an increased bandwidth to cover the required operation band.

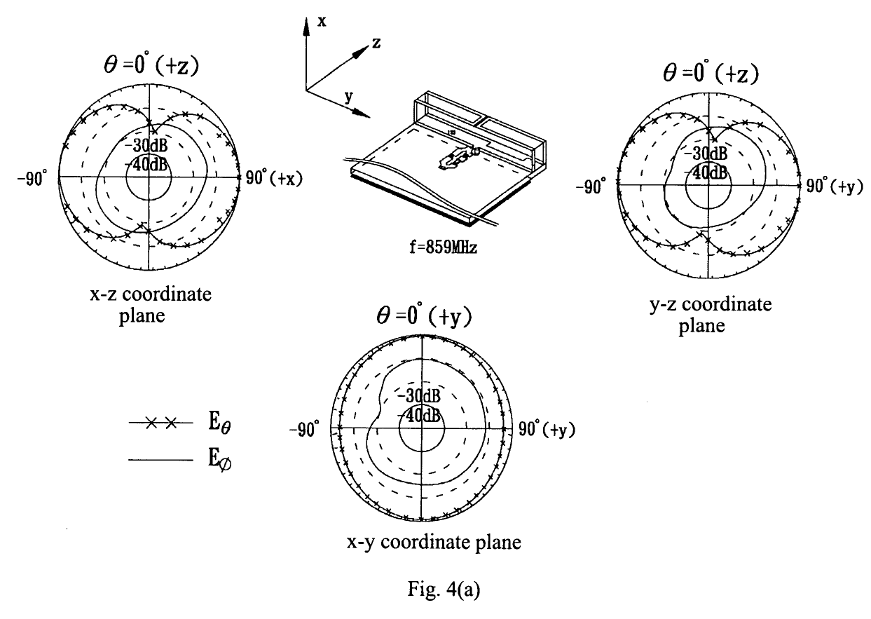

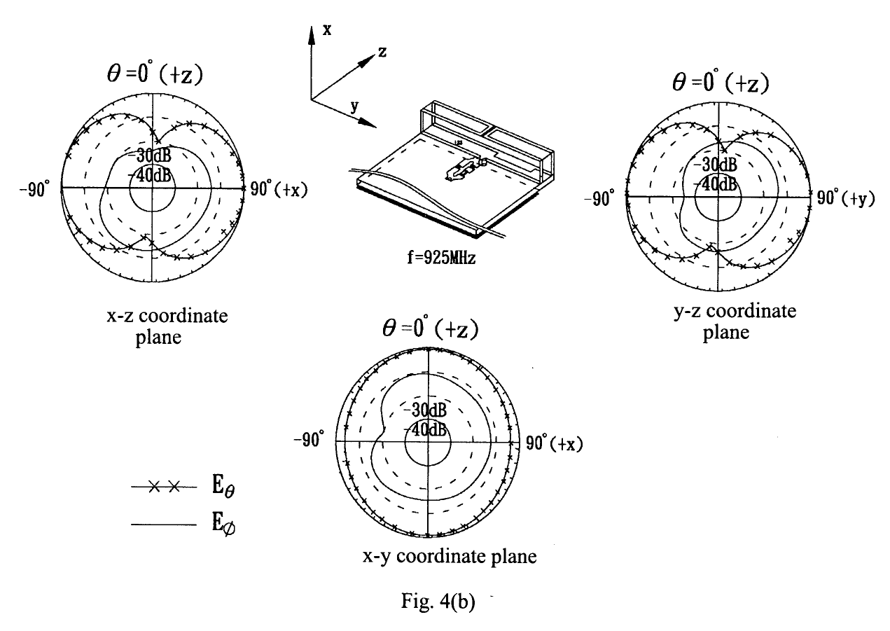

FIG. 4 illustrates the radiation field patterns of the antenna 1 according to the first embodiment of the present invention when providing operation covering GSM 850/900 bands, wherein FIG. 4(a) illustrates the radiation field patterns at a frequency of 859 MHz and FIG. 4(b) illustrates the radiation field patterns at a frequency of 925 MHz. The low frequency band 21 of the antenna 1 covering these operation bands is of the 0.5-wavelength resonant mode. As shown in FIG. 4, the radiation field patterns of the 0.5-wavelength resonant mode resonating on the loop strip is similar to the radiation field patterns of the conventional monopole antenna or planar antenna resonating at the same frequencies.

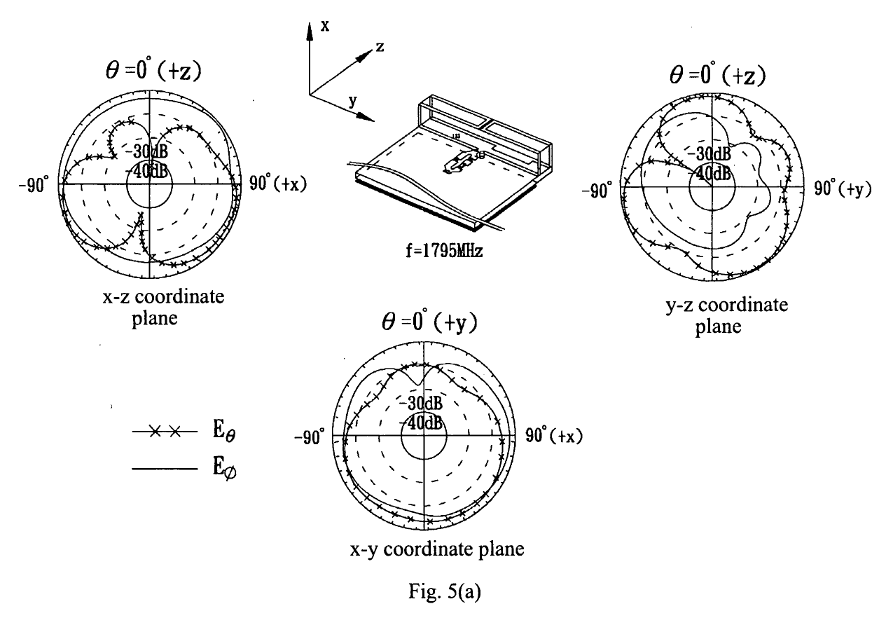

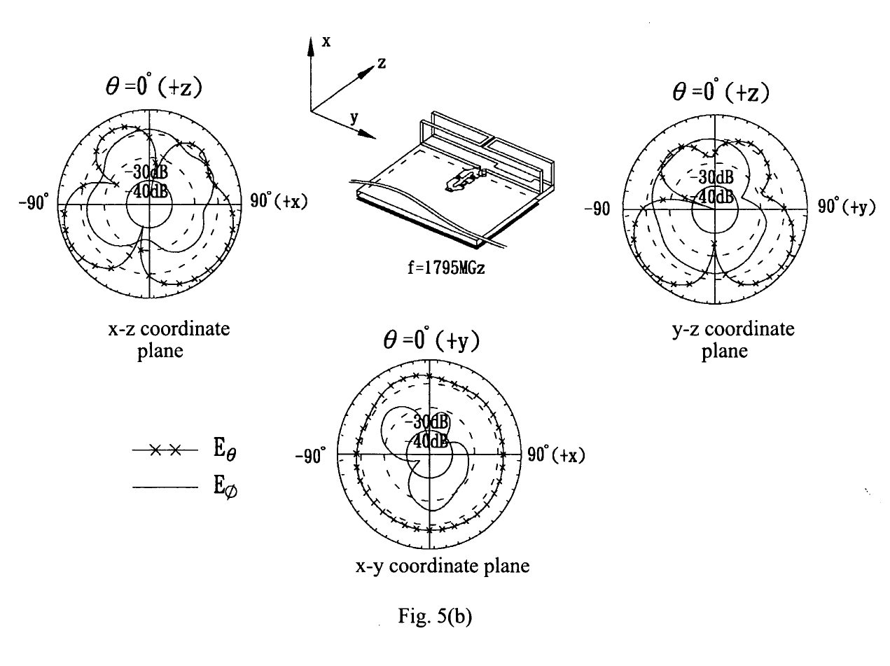

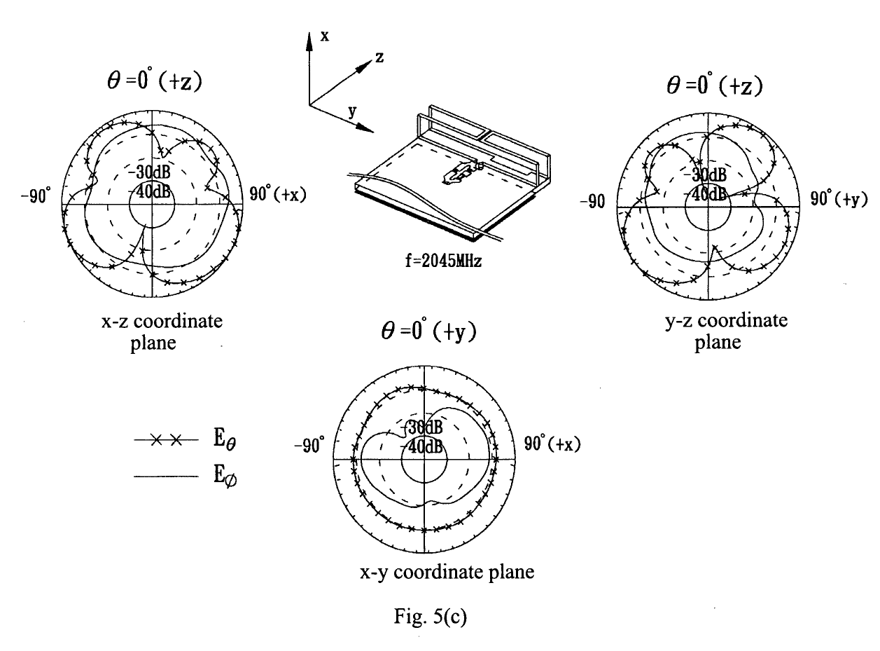

FIG. 5 illustrates the radiation field patterns of the antenna 1 according to the first embodiment of the present invention when providing operation covering GSM 1800/1900/UMTS bands, and FIG. 5(a) illustrates the radiation field patterns at a frequency of 1795 MHz, FIG. 5(b) illustrates the radiation field patterns at a frequency of 1920 MHz, and FIG. 5(c) illustrates the radiation field patterns at a frequency of 2045 MHz. The high frequency band 22 of the antenna 1 covering these operation bands is synthesized from the full-wavelength resonant mode and the 1.5-wavelength resonant mode of the antenna. As shown in FIG. 5, the radiation field patterns within the high frequency band 22, as being affected by the current zero on the ground plane, have more depressions in the radiation field patterns on x-z and y-z planes compared to the radiation field patterns within the low frequency band 21. However, such depressions do not affect the practical application of the antenna 1.

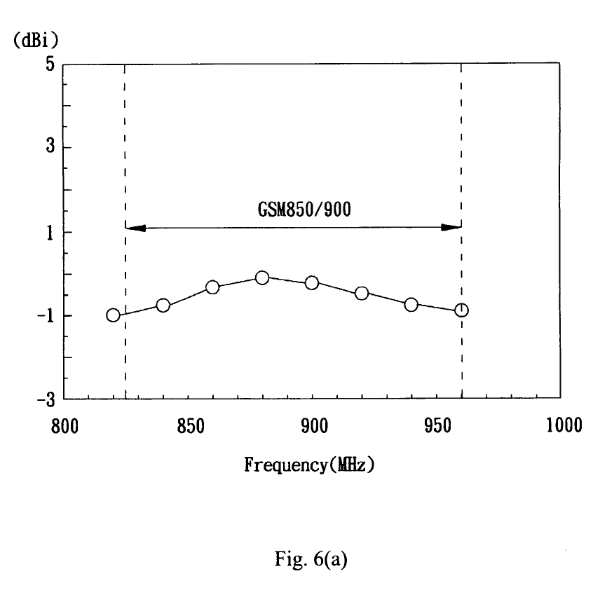

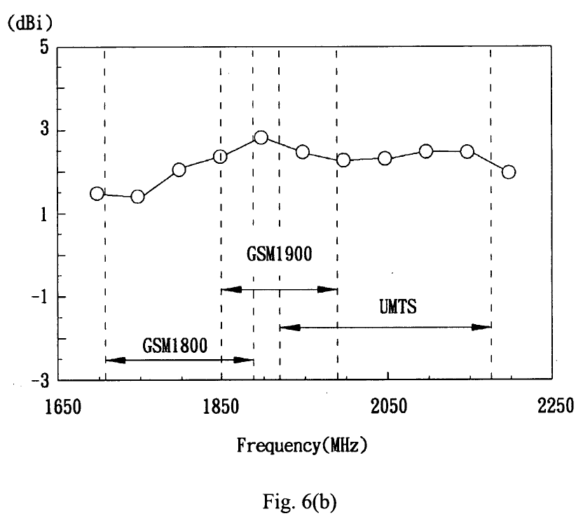

FIG. 6 illustrates the antenna gain graphs of the antenna 1 according to the first embodiment of the present invention in different operation bands, wherein FIG. 6(a) illustrates the antenna gain graph in GSM 850/900 bands, and FIG. 6(b) illustrates the antenna gain graph in GSM 1800/1900/UMTS bands. As can be found from the measured data, the antenna gain of the present invention is from about −1.0 to about −0.1 dBi in GSM 850/900 operation bands, and from about 1.7 to about 2.6 dBi in GSM 1800/1900/UMTS operation bands, and all meeting the requirement in practical application.

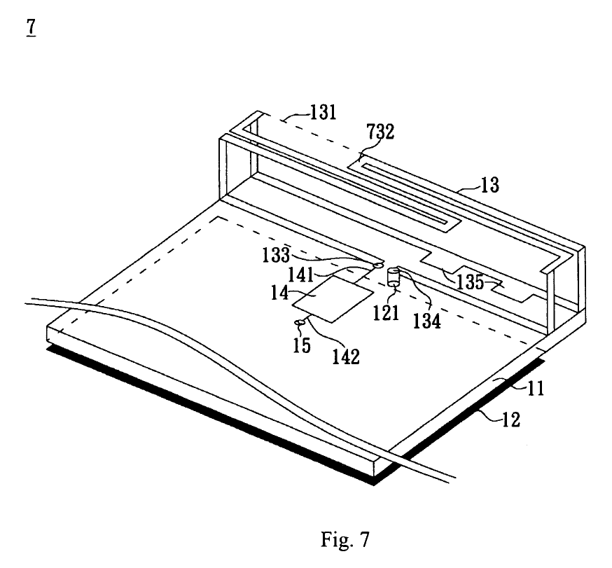

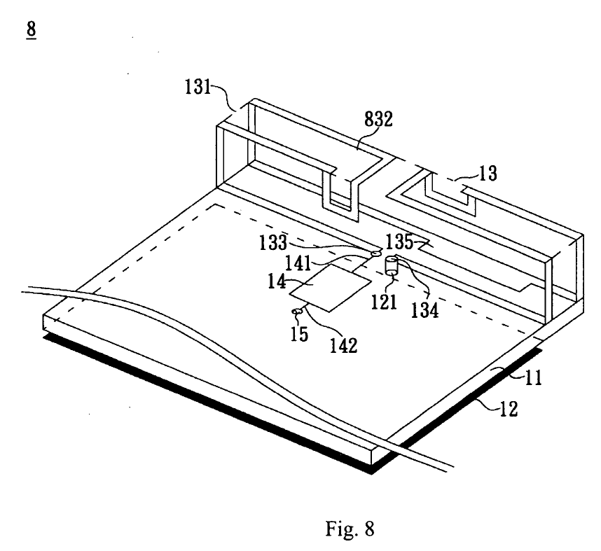

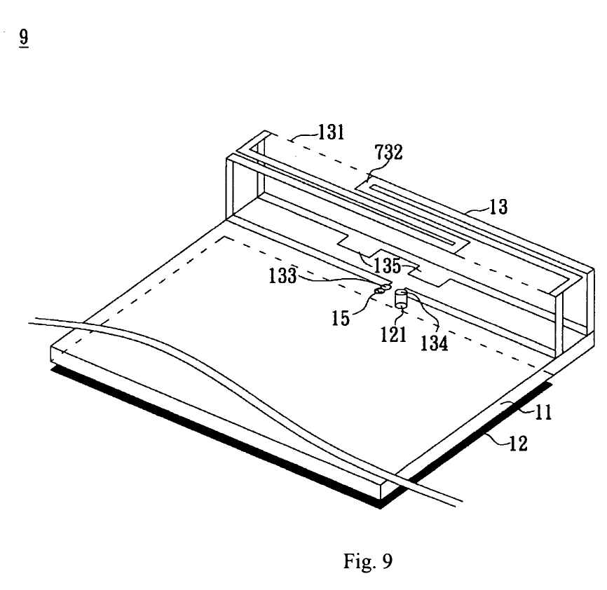

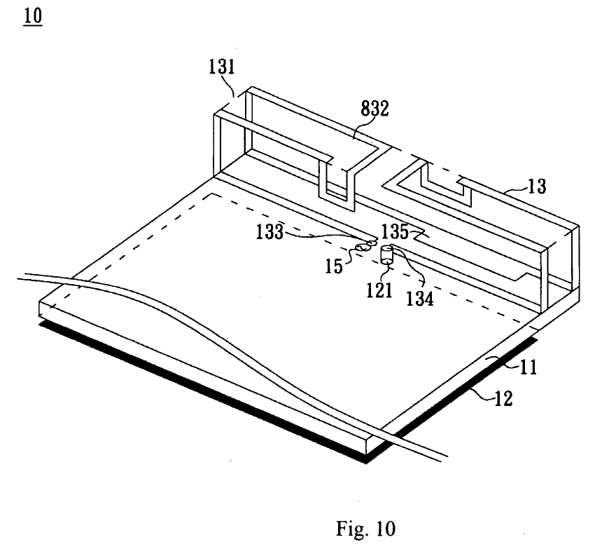

FIGS. 7, 8, 9, and 10 respectively illustrate the antenna 7, 8, 9, 10 according to a first, a second, a third, and a fourth derived embodiment of the present invention. The structures of antennas 7 and 8 according to the first and second derived embodiments of the present invention are substantially similar to the antenna 1 according to the first embodiment, and the structures of the antennas 9 and 10 according to the third and fourth derived embodiments are substantially similar to the antenna 2 according to the second embodiment, except that the loop strips 732 and 832 for the antennas 7, 9 and the antennas 8, 10, respectively, are folded in manners different from the loop strips 132 for the antennas 1, 2. The antennas 7 and 9 have two tuning patches 135. However, all the four derived embodiments of the present invention are able to achieve the same function as the two embodiments.

The results from the experiment conducted on the antenna of the present invention indicate that the antenna of the present invention is suitable for use as a cell phone antenna to cover all the five GSM 850/900/1800/1900/UMTS bands. The low frequency band 21 covering GSM 850/900 bands has a bandwidth of about 200 MHz from 810 to 1010 MHz, and the high frequency band 22 covering GSM 1800/1900/UMTS bands has a bandwidth of about 615 MHz from 1635 to 2250 MHz, and both low frequency band 21 and high frequency band 22 meet the application requirements for using with cell phone systems.

In brief, the antenna according to the present invention has simplified structure, definite operating mechanism, low manufacturing cost, and reduced antenna size while maintains the multiband antenna characteristic. Therefore, the antenna of the present invention is highly valuable in terms of its wide industrial applications.

The present invention has been described with some embodiments thereof and it is understood that many changes and modifications in the described embodiments can be carried out without departing from the scope and the spirit of the invention that is intended to be limited only by the appended claims.

What is claimed is:

1. A multiband folded loop antenna, comprising:
a dielectric substance;
a ground plane located on the dielectric substrate and having a grounding point;
a radiating portion comprising:
a supporter;
a loop strip having a length about half wavelength of a lowest resonant frequency of the antenna, and having a feeding end and a grounding end, wherein the ground end is electrically connected to the grounding point of the ground plane, and the loop strip is folded into a three-dimensional structure and supported by the supporter; and
at least one tuning patch electrically connected to the loop strip; and
a matching circuit located on the dielectric substrate, and electrically connected at one terminal to the feeding end of the loop strip of the radiating portion and at another terminal to a signal source.

2. The multiband folded loop antenna of claim 1, wherein the dielectric substrate is a system circuit board of a mobile communication apparatus.

3. The multiband folded loop antenna of claim 1, wherein the ground plane is a system ground plane of a mobile communication apparatus.

4. The multiband folded loop antenna of claim 1, wherein the ground plane is formed on the dielectric substrate by printing or etching.

5. The multiband folded loop antenna of claim 1, wherein the material of the supporter is selected from the group consisting of air, a fiberglass substrate, a plastic material, and a ceramic material.

6. The multiband folded loop antenna of claim 1, wherein the matching circuit comprises at least one capacitance element and at least one inductance element.

7. A multiband folded loop antenna, comprising:
a dielectric substance;
a ground plane located on the dielectric substrate and having a grounding point; and
a radiating portion comprising:
a supporter;
a loop strip having a length about half wavelength of a lowest resonant frequency of the antenna, and having a feeding end and a grounding end, wherein the feeding end is connected to a signal source, and the grounding end is electrically connected to the grounding point of the ground plane, and the loop strip is folded into a three-dimensional structure and supported by the supporter; and
at least one tuning patch electrically connected to the loop strip.

8. The multiband folded loop antenna of claim 7, wherein the dielectric substrate is a system circuit board of a mobile communication apparatus.

9. The multiband folded loop antenna of claim 7, wherein the ground plane is a system ground plane of a mobile communication apparatus.

10. The multiband folded loop antenna of claim 7, wherein the ground plane is formed on the dielectric substrate by printing or etching.

11. The multiband folded loop antenna of claim 7, wherein the material of the supporter is selected from the group consisting of air, a fiberglass substrate, a plastic material, and a ceramic material.
